(19) United States
(12) Patent Application Publication
(10) Pub. No.: US 2024/0141153 A1
(43) Pub. Date: May 2, 2024

(54) PROPYLENE BASED POLYMER COMPOSITION

(71) Applicant: Basell Poliolefine Italia S.r.l., Milano (IT)

(72) Inventors: Monica Galvan, Ferrara (IT); Roberta Marchini, Ferrara (IT); Michele Grazzi, Ferrara (IT); Claudio Cavalieri, Ferrara (IT)

(73) Assignee: Basell Poliolefine Italia S.r.l., Milano (IT)

(21) Appl. No.: 18/280,880

(22) PCT Filed: Mar. 3, 2022
(86) PCT No.: PCT/EP2022/055489

§ 371 Date: Sep. 7, 2023

(30) Foreign Application Priority Data
Mar. 9, 2021 (EP) 21161541.4

(51) Int. Cl. C08L 23/14; C08J 5/18; C08L 23/08; C08L 23/16

(52) U.S. Cl. CPC C08L 23/142; C08J 5/18; C08L 23/0815; C08L 23/16; C08J 2323/14; C08J 2323/16; C08J 2323/22; C08L 2203/16; C08L 2205/025; C08L 2205/03

(57) ABSTRACT

A polymer composition made from or containing:
A) from 70 wt % to 95 wt % of a propylene-based polymer composition made from or containing:
a) from 15 wt % to 35 wt % of a copolymer of propylene and 1-hexene containing from 6.2 to 8.5% by weight, of 1-hexene derived units;
b) from 15 wt % to 35 wt % of a copolymer of propylene and 1-hexene containing from 10.4 wt % to 14.5 wt %, of 1-hexene derived units; and
c) from 38 wt % to 68 wt % of a propylene ethylene copolymer,
wherein the sum of the amount of a), b), and c) being 100; and
B) from 5.0 wt % to 30.0 wt % of a copolymer of 1-butene and ethylene containing from 3.0 wt % to 4.2 wt % of ethylene derived units;
   wherein the sum of the amounts of A) and B) being 100 wt %.

### FIELD OF THE INVENTION

In general, the present disclosure relates to the field of chemistry. More specifically, the present disclosure relates to polymer chemistry. In particular, the present disclosure relates to propylene compositions and films made therefrom.

### BACKGROUND OF THE INVENTION

In some instances, copolymers of propylene and 1-hexene have a molecular weight distribution of monomodal type and are used for pipes systems.

In some instances, compositions made from or containing copolymers of propylene with 1-hexene and a copolymer of propylene and ethylene are used for preparing films, including biaxially oriented polypropylene films (BOPP) and cast films.

In some instances, polypropylene compositions are used for making films in the packaging field and for producing non-packaging items.

Packaging examples include primary packaging of hygienic items, textile articles, magazines, and mailing films, secondary collation packaging, shrink packaging films and sleeves, stretch packaging films and sleeves, form-fill-seal packaging films, and vacuum formed blisters.

### SUMMARY OF THE INVENTION

In a general embodiment, the present disclosure provides a polymer composition made from or containing:
A) from 70 wt % to 95 wt % of a propylene-based polymer composition made from or containing:
a) from 15 wt % to 35 wt % of a copolymer of propylene and 1-hexene containing from 6.2 to 8.5% by weight, based upon the total weight of the copolymer of propylene and 1-hexene (a), of 1-hexene derived units and having a Melt Flow Rate (MFR, measured according to ASTM D 1238-13, 230° C./2.16 kg, that is, at 230° C., with a load of 2.16 kg) from 3.5 to 8.5 g/10 min;
b) from 15 wt % to 35 wt % of a copolymer of propylene and 1-hexene containing from 10.4 to 14.5% by weight, based upon the total weight of the copolymer of propylene and 1-hexene (b), of 1-hexene derived units and having a Melt Flow Rate (MFR, measured according to ASTM D 1238-13, 230° C./2.16 kg, that is, at 230° C., with a load of 2.16 kg) from 3.5 to 8.5 g/10 min; and
c) from 38 wt % to 68 wt % of a copolymer of propylene and ethylene containing from 3.4 wt % to 5.7 wt %, based upon the total weight of the copolymer of propylene and ethylene (c), of ethylene derived units, having a Melt Flow Rate (MFR, measured according to ASTM D 1238-13, 230° C./2.16 kg, that is, at 230° C., with a load of 2.16 kg) from 3.5 to 12.0 g/10 min, and having a xylene soluble content at 25° C. of from 3.7 wt % to 7.8 wt %, based upon the total weight of the copolymer of propylene and ethylene (c);
the sum of the amount of components a), b), and c) in the propylene-based polymer composition being 100 wt %;
wherein:
i) the total amount of 1-hexene derived units of the components a) and b) ranges from 9.4 wt % to 11.6 wt %, based upon the combined weight of components a) and b);
ii) the xylene soluble content at 25° C. ranges from 14.2 wt % to 19.3 wt %, based upon the total weight of the propylene-based polymer composition;
iii) the 1-hexene-derived units content ranges from 3.7 wt % to 6.4 wt %, based upon the total weight of the propylene-based polymer composition; and
iv) the propylene-based polymer composition has a melting point ranging from 128° C. to 135° C.; and
B) from 5.0 wt % to 30.0 wt % of a copolymer of 1-butene and ethylene containing from 3.0 wt % to 4.2 wt %, based upon the total weight of the copolymer of 1-butene and ethylene, of ethylene derived units and having
a Melt Flow Rate: measured according to ISO 1133-1 (190° C., 2.16 Kg) ranging from 1.0 to 5.5 g/10 min;
a flexural modulus measured according to ISO 178 ranging from 80 MPa to 250 MPa; and
a melting temperature measured according to ISO 11357-3 ranging from 83° C. to 108° C., form I, wherein the sum of the amounts of A) and B) being 100 wt %.

### DETAILED DESCRIPTION OF THE INVENTION

In some embodiments, the present disclosure provides a polymer composition made from or containing:
A) from 70.0 wt % to 95.0 wt %, alternatively from 74.0 wt % to 87.0 wt %, alternatively from 77.0 wt % to 86.0 wt, of a propylene-based polymer composition made from or containing:
a) from 15 wt % to 35 wt %, alternatively from 20 wt % to 31 wt %; alternatively from 22 wt % to 28 wt %, of a copolymer of propylene and 1-hexene containing from 6.2 wt % to 8.5 wt %, alternatively from 6.8 wt % to 8.1 wt %; alternatively from 7.1 wt % to 7.9 wt %, based upon the total weight of the copolymer of propylene and 1-hexene (a), of 1-hexene derived units and having a Melt Flow Rate (MFR, measured according to ASTM D 1238-13, 230° C./2.16 kg, that is, at 230° C., with a load of 2.16 kg) from 3.5 to 8.5 g/10 min, alternatively ranging from 4.4 to 8.0 g/10 min; alternatively ranging from 5.0 to 7.0 g/10 min;
b) from 15 wt % to 35 wt %, alternatively from 20 wt % to 31 wt %; alternatively from 22 wt % to 28 wt %, of a copolymer of propylene and 1-hexene containing from 10.4 wt % to 14.5 wt %; alternatively from 11.2 wt % to 13.9 wt %; alternatively from 11.6 wt % to 13.3 wt %, based upon the total weight of the copolymer of propylene and 1-hexene (b), of 1-hexene derived units having a Melt Flow Rate (MFR, measured according to ASTM D 1238-13, 230° C./2.16 kg, that is, at 230° C., with a load of 2.16 kg) from 3.5 to 8.5 g/10 min, alternatively ranging from 4.4 to 8.0 g/10 min; alternatively ranging from 5.0 to 7.0 8.5 g/10 min; and
c) from 38 wt % to 68 wt %; alternatively from 42 wt % to 62 wt %; alternatively from 45 wt % to 58 wt %, of a copolymer of propylene and ethylene containing from 3.4 wt % to 5.7 wt %; alternatively from 3.9 wt % to 5.1 wt %; alternatively from 4.2 wt % to 4.9 wt %, based upon the total weight of the copolymer of propylene and ethylene (c), of ethylene derived units, having a Melt Flow Rate (MFR, measured according to ASTM D 1238-13, 230° C./2.16 kg, that is, at 230° C., with a load of 2.16 kg) from 3.5 to 12.0 g/10 min, alternatively from 3.5 to 8.5 g/10 min, alternatively ranging from 4.4 to 8.0 g/10 min; alternatively ranging from 5.0 to 7.0 g/10 min, and having a xylene soluble content at 25° C. ranging from 3.7 wt % to 7.8 wt %; alternatively from 4.1 wt % to 6.8 wt %, alternatively from 4.6 wt % to 6.2 wt %, based upon the total weight of the copolymer of propylene and ethylene (c);
the sum of the amount of components a), b), and c) in the propylene-based polymer composition being 100 wt %;
wherein:
i) the total amount of 1-hexene derived units of components a) and b) ranges from 9.4 wt % to 11.6 wt %; alternatively from 9.5 wt % to 11.5 wt %; alternatively from 9.6 wt % to 10.8 wt %, based upon the combined weight of components a) and b);
ii) the xylene soluble content at 25° C. ranges from 14.2 wt % to 19.3 wt %; alternatively from 15.3 wt % to 18.7 wt %; alternatively from 16.2 wt % to 18.1 wt %, based upon the total weight of the propylene-based polymer composition;
iii) the 1-hexene derived units content ranges from 3.7 wt % to 6.4 wt %; alternatively from 3.9 wt % to 5.4 wt %; alternatively from 4.2 wt % to 5.2 wt %, based upon the total weight of the propylene-based polymer composition; and
iv) the propylene-based polymer composition has a melting point ranging from 128° C. to 135° C.; alternatively from 129° C. to 133° C.; and
B) from 5.0 wt % to 30.0 wt %; alternatively from 13.0 wt % to 26.0 wt %; alternatively from 14.0 wt % to 23 wt %, of a copolymer of 1-butene and ethylene containing from 3.0 wt % to 4.2 wt %, alternatively from 3.2 wt % to 4.0 wt %; alternatively from 3.3 wt % to 3.9 wt %, based upon the total weight of the copolymer of 1-butene and ethylene, of ethylene derived units and having
a Melt Flow Rate: measured according to ISO 1133-1-(190° C., 2.16 Kg) ranging from 1.0 to 5.5 g/10 min, alternatively from 2.1 to 4.8 g/10 min; alternatively from 2.4 to 4.1 g/10 min;
a flexural modulus measured according to ISO 178 ranging from 50 MPa to 250 MPa; alternatively ranging from 80 MPa to 210 MPa; alternatively ranging from 92 MPa, to 174 MPa; and
a melting temperature measured according to ISO 11357-3 ranging from 83° C. to 108° C., alternatively ranging from 84° C. to 103° C.; alternatively ranging from 88° C. to 100° C., form I;
wherein the sum of the amounts of A) and B) being 100 wt %.

As used herein, the term “copolymer” refers to polymers containing two comonomers such as 1-butene and ethylene, propylene 1-hexene, propylene and ethylene derived units. In some embodiments, component B) is made from or containing the comonomers 1-butene and ethylene, in the absence of other comonomers.

In some embodiments, the copolymer of 1-butene and ethylene B) is commercially available, under the tradename Koattro DP 8310M from LyondellBasell. In some embodiments, the copolymer of 1-butene and ethylene B) is using Ziegler Natta catalysts.

In some embodiments, the polymer composition is prepared by mechanically blending component A) and component B).

In some embodiments, the polymer composition is used for the production of film, alternatively cast or biaxially oriented polypropylene films (BOPP) films.

In some embodiments, the present disclosure provides a film made from or containing the polymer composition. In some embodiments, the present disclosure provides a multilayer film having a sealing layer made from or containing the polymer composition.

In some embodiments, the multilayer films have a sealing layer made from or containing the polymer composition and other layers. In some embodiments, each layer is formed of a polypropylene homopolymer, polypropylene copolymer, polyethylene homopolymer, polyethylene copolymer, or other polymers. In some embodiments, the other polymer is EVA.

In some embodiments, the combination and number of the layers of the multilayer structure is not limited. In some embodiments, the number is from 3 to 11 layers or even more, alternatively 3 to 9 layers, alternatively 3 to 7 layers, alternatively 3 to 5 layers. In some embodiments, the combinations include CB/A, CB/CB/A, and C/B/C/D/C/B/A, wherein layer A is a sealing layer made from or containing the polymer composition.

In some embodiments, the layers of the multilayer film are 3 or 5, wherein the sealing layer is made from or containing the polymer composition.

In some embodiments, the Seal Initiating Temperature (SIT) value is between 70° C. and 55° C.; alternatively between 67° C. and 56° C. In some embodiments, the difference between the melting point and the SIT (Tm-SIT) ranges from 60° C. to 75° C.; alternatively from 63° C. to 73° C.

In some embodiments, the sum of components a)+b) have a 1-hexene derived units content in the fraction soluble in xylene at 25° C. between 18.0 wt % and 32.0 wt %; alternatively from 21.0 wt % and 30.0 wt %, based upon the combined weight of components a) and b).

In some embodiments, component c) has an ethylene derived units content in the fraction soluble in xylene at 25° C. between 10.0 wt % and 17.0 wt %; alternatively between 11.0 wt % and 16.0 wt %; alternatively between 13.0 wt % and 15.0 wt %, based upon the total weight of the copolymer of propylene and ethylene (c).

In some embodiments, components a), b), and c) of the propylene-based polymer composition are obtained with polymerization processes carried out in the presence of a catalyst made from or containing the product of a reaction between:
a solid catalyst component made from or containing Ti, Mg, Cl, and an electron donor compound containing from 0.1 to 50% wt of Bi with respect to the total weight of the solid catalyst component;
(ii) an alkylaluminum compound; and
(iii) an external electron-donor compound having the formula:

(R¹)ₐSi(OR²)_{b}
wherein R¹ and R² are independently selected among alkyl or cycloalkyl radicals with 1-8 carbon atoms and a+b=4.

In some embodiments, the external donor is an ester of glutaric acid, alternatively an alkyl ester of glutaric acid; alternatively the ester of glutaric acid is used in a mixture with 9,9-bis(alkoxymethyl)fluorene. In some embodiments, the molar ratio between esters of glutaric acid and 9,9-bis(alkoxymethyl)fluorene is from 50:50 to 90:10; alternatively from 60:40 to 80:20; alternatively from 65:35 to 75:25. In some embodiments, the alkyl radical is a C₁-C₁₀ alkyl radical. In some embodiments, the C₁-C₁₀ alkyl radical is selected from the group consisting of a methyl, ethyl propyl; butyl radicals. In some embodiments, the alkyl ester of glutaric acid is 1 3,3-dipropylglutarate. In some embodiments, the 9,9-bis(alkoxymethyl)fluorene is 9,9-bis(methoxymethyl)fluorene.

In some embodiments and in the catalyst component, the content of Bi ranges from 0.5 to 40% wt, alternatively from 1 to 35% wt, alternatively from 2 to 25% wt, alternatively from 2 to 20% wt, based upon the total weight of the solid catalyst component.

In some embodiments, the particles of the solid component have substantially spherical morphology and an average diameter ranging between 5 and 150 alternatively from 20 to 100 alternatively from 30 to 90 As used herein, the term “substantially spherical morphology” refers to particles having the ratio between the greater axis and the smaller axis equal to or lower than 1.5, alternatively lower than 1.3.

In some embodiments, the amount of Mg ranges from 8 to 30% wt, alternatively from 10 to 25% wt, based upon the total weight of the solid catalyst component.

In some embodiments, the amount of Ti ranges from 0.5 to 5% wt, alternatively from 0.7 to 3% wt, based upon the total weight of the solid catalyst component.

In some embodiments, the Mg/Ti molar ratio is equal to, or higher than, 13, alternatively in the range of 14 to 40, alternatively from 15 to 40. In some embodiments, the Mg/donor molar ratio is higher than 16, alternatively higher than 17, alternatively ranging from 18 to 50.

In some embodiments, the Bi atoms are derived from one or more Bi compounds not having Bi-carbon bonds. In some embodiments, the Bi compounds are selected from the group consisting of Bi halides, Bi carbonate, Bi acetate, Bi nitrate, Bi oxide, Bi sulfate, and Bi sulfide. In some embodiments, the Bi compounds have the valence state of 3+. In some embodiments, the Bi compounds are selected from the group consisting of Bi trichloride and Bi tribromide. In some embodiments, the Bi compound is BiCl₃.

In some embodiments, the solid catalyst component is prepared by reacting a titanium compound of the formula Ti(OR)_{q-y}X_{y}, where q is the valence of titanium and y is a number between 1 and q, with a magnesium chloride deriving from an adduct of formula MgCl₂·pROH, where p is a number between 0.1 and 6, alternatively from 2 to 3.5, and R is a hydrocarbon radical having 1-18 carbon atoms. In some embodiments, the titanium compound is TiCl₄. In some embodiments, the adduct is prepared in spherical form by mixing alcohol and magnesium chloride, operating under stirring conditions at the melting temperature of the adduct (100-130° C.). Then, the adduct is mixed with an inert hydrocarbon immiscible with the adduct, thereby creating an emulsion which is quickly quenched, causing the solidification of the adduct in form of spherical particles. In some embodiments, the procedure for the preparation of the spherical adducts is as disclosed in U.S. Pat. Nos. 4,399,054 and 4,469,648. In some embodiments, the resulting adduct is directly reacted with a Ti compound or subjected to thermally controlled dealcoholation (80-130° C.), thereby obtaining an adduct wherein the number of moles of alcohol is lower than 3, alternatively between 0.1 and 2.5. In some embodiments, the reaction with the Ti compound is carried out by suspending the adduct (dealcoholated or not) in cold TiCl₄; the mixture is heated up to 80-130° C. and kept at this temperature for 0.5-2 hours. In some embodiments, the temperature of the cold TiCl₄ is 0° C. In some embodiments, the treatment with TiCl₄ is carried out one or more times. In some embodiments, the electron donor compound is added during the treatment with TiCl₄.

Several ways are available to add one or more Bi compounds in the catalyst preparation. In some embodiments, the Bi compound(s) is/are incorporated directly into the MgCl₂·pROH adduct during the adduct's preparation. In some embodiments, the Bi compound is added at the initial stage of adduct preparation by mixing the Bi compound together with MgCl₂ and the alcohol. In some embodiments, the Bi compound is added to the molten adduct before the emulsification step. The amount of Bi introduced ranges from 0.1 to 1 mole per mole of Mg in the adduct. In some embodiments, the Bi compound(s), which are incorporated directly into the MgCl₂·pROH adduct, are Bi halides, alternatively BiCl₃.

In some embodiments, the alkyl-Al compound (ii) is selected from the group consisting of trialkyl aluminum compounds, alkylaluminum halides, alkylaluminum hydrides, and alkylaluminum sesquichlorides. In some embodiments, the alkyl-Al compound (ii) is a trialkyl aluminum compound selected from the group consisting of triethylaluminum, triisobutylaluminum, tri-n-butylaluminum, tri-n-hexylaluminum, and tri-n-octylaluminum. In some embodiments, the alkyl-Al compound (ii) is an alkylaluminum sesquichlorides selected from the group consisting of AlEt₂Cl and Al₂Et₃Cl₃. In some embodiments, the alkyl-Al compound (ii) is a mixture including trialkylaluminums. In some embodiments, the Al/Ti ratio is higher than 1, alternatively between 50 and 2000.

The external electron donor compound (iii) is a silicon compound having the formula:

(R¹)ₐSi(OR²)_{b} (II)
wherein R¹ and R 2 are independently selected among alkyl or cycloalkyl radicals with 1-8 carbon atoms, optionally containing heteroatoms, wherein a+b=4.

In some embodiments, the silicon compounds of formula II are selected from the group consisting of (tert-butyl)₂Si(OCH₃)₂, (cyclopentyl)₂Si(OCH₃)₂, and (cyclohexyl) (methyl)Si(OCH₃)2.

In some embodiments, the external electron donor compound (iii) is used in an amount to give a molar ratio between the alkylaluminum compound (ii) and the external electron donor compound (iii) of from 0.1 to 200, alternatively from 1 to 100, alternatively from 3 to 50.

In some embodiments, the polymerization process is continuous or batch. In some embodiments, the polymerization process is operated in gas phase, in liquid phase, or by mixed liquid-gas techniques. In some embodiments, the liquid phase is operated in the presence of an inert diluent. In some embodiments, the liquid phase is operated in the absence of an inert diluent. In some embodiments, the polymerization is carried out in gas phase in three reactors, with a reactor for each component of the propylene-based polymer composition. In some embodiments and in the first two reactors, components a) and b) respectively are obtained while component c) is obtained in the third and last reactor.

In some embodiments, the polymerization temperature is from 20 to 100° C. In some embodiments, the pressure is atmospheric or higher.

In some embodiments, the molecular weight is regulated. In some embodiments, the molecular weight regulator is hydrogen.

In some embodiments, the polymer composition contains additives. In some embodiments, the additives are selected from the group consisting of nucleating agents, clarifying agents, and processing aids.

In some embodiments, the polymer composition has a number of gels No(>0.1 mm) of Less than 2.50 alternatively less than 150.

In some embodiments, the polymer composition is used for the production of films. In some embodiments, cast or BOPP film mono or multilayer have at least one layer made from or containing the polymer composition.

### EXAMPLES

The following examples are given for illustration without limiting purpose.

The data relating to the polymeric materials and the films of the examples are determined by the methods reported below.

Melting and Crystallization Temperature (ISO 11357-2013)

Determined by differential scanning calorimetry (DSC).according to ISO 11357-20133, at scanning rate of 20° C./min both in cooling and heating, on a sample of weight between 5 and 7 mg., under inert N2 flow. The instrument was calibrated with Indium.

Melting Temperature of Component B)

The melting temperature TmI is the melting temperature attributable to the crystalline form I of the copolymer. To determine the TmI, the copolymer sample was melted, cooled down to 20° C. with a cooling rate of 10° C./min., kept for 10 days at room temperature, subjected to differential scanning calorimetry (DSC) analysis by cooling to −20° C., and heating to 200° C. with a scanning speed corresponding to 10° C./min. In the heating run, the peak in the thermogram is taken as the melting temperature (Tml).

Melt Flow Rate (MFR)

Determined according to ASTM D 1238-13, at 230° C., with a load of 2.16 kg or ISO 1133-1 at 190° C., 2.16 Kg.

Solubility in Xylene at 25° C.

Xylene Solubles was measured according to ISO 16 152-2005; with solution volume of 250 ml, precipitation at 25° C. for 20 minutes, including 10 minutes with the solution in agitation (magnetic stirrer), and drying at 70°.

¹³C NMR of propylene/ethylene copolymers

¹³C NMR spectra were acquired on a Bruker AV-600 spectrometer equipped with cryoprobe, operating at 160.91 MHz in the Fourier transform mode at 120° C.

The peak of the S_{ββ} carbon (nomenclature according to “Monomer Sequence Distribution in Ethylene-Propylene Rubber Measured by 13C NMR. 3. Use of Reaction Probability Mode” C. J. Carman, R. A. Harrington and C. E. Wilkes, Macromolecules, 1977, 10, 536) was used as internal standard at 29.9 ppm. The samples were dissolved in 1,1,2,2-tetrachloroethane-d2 at 120° C. with an 8% wt/v concentration. Each spectrum was acquired with a 90° pulse, 15 seconds of delay between pulses and CPD, thereby removing 1H-13C coupling. 512 transients were stored in 32K data points using a spectral window of 9000 Hz.

The assignments of the spectra, the evaluation of triad distribution and the composition were made according to Kakugo (“Carbon-13 NMR determination of monomer sequence distribution in ethylene-propylene copolymers prepared with 6-titanium trichloride-diethylaluminum chloride” M. Kakugo, Y. Naito, K. Mizunuma and T. Miyatake, Macromolecules, 1982, 15, 1150) using the following equations:

$$\begin{matrix}PPP = 100 {T}_{ββ} / S & PPE = 100 {T}_{βδ} / S & EPE = 100 {T}_{δδ} / S\end{matrix}$$

$$PEP = 100 {S}_{ββ} / S \qquad PEE = 100 {S}_{βδ} / S \qquad EEE = 100 ( 0.25 {S}_{γδ} + 0.5 {S}_{δδ} / S$$

$$S = {T}_{ββ} + {T}_{βδ} + {T}_{δδ} + {S}_{ββ} + {S}_{βδ} + 0.25 {S}_{γδ} + 0.5 {S}_{δδ}$$

The molar percentage of ethylene content was evaluated using the following equation:

E % mol=100*[PEP+PEE+EEE]

The weight percentage of ethylene content was evaluated using the following equation:

$$E \% wt . = \frac{* E \% mol * {MW}_{E}}{E \% mol * {MW}_{E +} P \% mol * {MW}_{P}}$$

where P % mol is the molar percentage of propylene content, while MW_{E} and MW_{P} are the molecular weights of ethylene and propylene, respectively.

The product of reactivity ratio r₁r₂ was calculated according to Carman (C. J. Carman, R. A. Harrington and C. E. Wilkes, Macromolecules, 1977; 10, 536) as:

$${r}_{1} {r}_{2} = 1 + ( \frac{EEE + PEE}{PEP} + 1 ) - ( \frac{P}{E} + 1 ) {( \frac{EEE + PEE}{PEP} + 1 )}^{0.5}$$

The tacticity of propylene sequences was calculated as mm content from the ratio of the PPP mmT_{ββ} (28.90-29.65 ppm) and the whole T_{ββ} (29.80-28.37 ppm).

1-Hexene and Ethylene Content:

Determination of 1-hexene content by NMR

¹³C NMR spectra were acquired on an AV-600 spectrometer, operating at 150.91 MHz in the Fourier transform mode at 120° C. The peak of the propylene CH was used as internal standard at 28.83. The ¹³C NMR spectrum was acquired using the following parameters:

| Spectral width (SW) | 60 | ppm |
|---|---|---|
| Spectrum center (O1) | 30 | ppm |
| Decoupling sequence | WALTZ 65_64pl | |
| Pulse program | ZGPG | |
| Pulse Length (P1) | for 90° | |
| Total number of points (TD) | 32K | |
| Relaxation Delay | 15 | s |

| | |
|---|---|
| Number of transients | 1500 |

The total amount of 1-hexene, as molar percent, was calculated from diad present in the measured NMR, using the following equations:

[P]=PP+0.5PH

[H]=HH+0.5PH

Assignments of the ¹³C NMR spectrum of propylene/1-hexene copolymers were calculated according to the following table:

| Area | Chemical Shift | Assignments | Sequence |
|---|---|---|---|
| 1 | 46.93-46.00 | S_{αα} | PP |
| 2 | 44.50-43.82 | S_{αα} | PH |
| 3 | 41.34-4.23 | S_{αα} | HH |
| 4 | 38.00-37.40 | S_{αγ} + S_{αδ} | PE |
| 5 | 35.70-35.0 | 4B₄ | H |
| 6 | 35.00-34.53 | S_{αγ} + S_{αδ} | HE |
| 7 | 33.7533.20 | CH | H |
| 8 | 33.24 | T_{δδ} | EPE |
| 9 | 30.92 | T_{βδ} | PPE |
| 10 | 30.76 | S_{γγ} | XEEX |
| 11 | 30.35 | S_{γδ} | XEEE |
| 12 | 29.95 | S_{δδ} | EEE |
| 13 | 29.35 | 3B₄ | H |
| 14 | 28.94-28.38 | CH | P |
| 15 | 27.43-27.27 | S_{βδ} | XEE |
| 16 | 24.67-24.53 | S_{ββ} | XEX |
| 17 | 23.44-23.35 | 2B₄ | H |
| 18 | 21.80-19.90 | CH₃ | P |
| 19 | 14.22 | CH₃ | H |

Determination of Ethylene and 1-Hexene Content by NMR

¹³C NMR spectra were acquired on an AV-600 spectrometer, operating at 150.91 MHz in the Fourier transform mode at 120° C. The peak of the propylene CH was used as internal standard at 28.83. The ¹³C NMR spectrum was acquired using the following parameters:

| Spectral width (SW) | 60 | ppm |
|---|---|---|
| Spectrum center (O1) | 30 | ppm |
| Decoupling sequence | WALTZ 16 | |
| Pulse program | ZGPG | |
| Pulse Length (P1) | for 90° | |
| Total number of points (TD) | 32K | |
| Relaxation Delay | 15 | s |

| | |
|---|---|
| Number of transients | 1500 |

Diad distribution was calculated according to the following equations:

PP=100I1/Σ

PH=100I2/Σ

HE=100I3/Σ

PE=100I4/Σ

EE=100(0.5(I12+I15)+0.25I11)/Σ
where Σ=I1+I2+I3+I4+0.5(I12+I15)+0.25 I11

The total amount of 1-hexene and ethylene as molar percent was calculated from diad using the following equations:

[P]=PP+0.5PH+0.5PE

[H]=HH+0.5PH

[E]=EE+0.5PE

Assignments of the ¹³C NMR spectrum of propylene/1-hexene/ethylene

Copolymers

| Area | Chemical Shift | Assignments | Sequence |
|---|---|---|---|
| 1 | 46.93-46.00 | S_{□□} | PP |
| 2 | 44.17-43.82 | S_{□□} | PH |
| 3 | 41.30 | S_{□□} | HH |
| 4 | 38.00-37.40 | S_{□□} + S_{□□} | PE |
| 5 | 35.70 | 4B₄ | H |
| 6 | 35.00-34.53 | S_{□□} + S_{□□} | HE |
| 7 | 33.75 | CH | H |
| 8 | 33.24 | T_{□□} | EPE |
| 9 | 30.92 | T_{□□} | PPE |
| 10 | 30.76 | S_{□□} | XEEX |
| 11 | 30.35 | S_{□□} | XEEE |
| 12 | 29.95 | S_{□□} | EEE |
| 13 | 29.35 | 3B₄ | H |
| 14 | 28.94-28.38 | CH | P |
| 15 | 27.43-27.27 | S_{□□} | XEE |
| 16 | 24.67-24.53 | S_{□□} | XEX |
| 17 | 23.36 | 2B₄ | H |
| 18 | 21.80-19.90 | CH₃ | P |
| 19 | 14.22 | CH₃ | H |

The amount of 1-hexene in component b was calculated using the equation:

C₆ₜₒₜ=C_{6A}*b+C_{6B}*b
wherein C₆ₜₒₜ is the amount of 1-hexene in the propylene-based polymer composition; C_{6A} is the amount of 1-hexene in component a); C_{6B} is the amount of 1-hexene in component b); a and b are the amount of components a) and b); and a)+b)=1.

The 1-hexene content of component b) was calculated from the 1-hexene total content of the propylene-based polymer composition using the formula C₆ₜₒₜ=C6ₐ×Wₐ+C6b×Wb, wherein C6 is the 1-hexene content and Wa and Wb are the amount of components a and b, respectively.

Ethylene Content in a 1-Butene Ethylene Copolymer

The content of comonomers was determined by infrared spectroscopy by collecting the IR spectrum of the sample vs. an air background with a Fourier Transform Infrared spectrometer (FTIR). The instrument data acquisition parameters were:
purge time: 30 seconds minimum
collect time: 3 minutes minimum
apodization: Happ-Genzel
resolution: 2 cm⁻¹.

Sample Preparation—Using a hydraulic press, a thick sheet was obtained by compression molding about 1 gram of sample between two sheets of aluminum foil. A small portion was cut from this sheet to mold a film. The film thickness was set to have a maximum absorbance of the CH₂ absorption band recorded at ˜720 cm⁻¹ of 1.3 a.u. (% Transmittance >5%). Molding conditions were a temperature of 180±10° C. (356° F.) with a pressure around 10 kg/cm² (142.2 PSI) for about one minute. The pressure was then released. The sample was removed from the press and cooled to room temperature. The spectrum of pressed film sample was recorded in absorbance vs. wavenumbers (cm⁻¹). The following measurements were used to calculate ethylene (C₂) and 1-butene (C₄) contents:
a) Area (Aₜ) of the combination absorption bands between 4482 and 3950 cm⁻¹ which was used for spectrometric normalization of film thickness.
b) Area (AC2) of the absorption band due to methylenic sequences (CH₂ rocking vibration) in the range 660 to 790 cm-1 after a digital subtraction of an isotactic polypropylene (IPP) and a C2C4 standard spectra.
c) The factor of subtraction (FCR_{C4}) between the spectrum of the polymer sample and the C₂C₄ standard spectrum. The standard spectrum was obtained by digital subtraction of a linear polyethylene from a C2C4 copolymer, thereby extracting the C₄ band (ethyl group at ˜771 cm−1).

The ratio A_{C2}/Aₜ was calibrated by analyzing standard ethylene-1-butene standard copolymer compositions, determined by NMR spectroscopy. To calculate the ethylene (C2) and 1-butene (C4) content, calibration curves were obtained using standards of ethylene and 1-butene detected by ¹³C-NMR.

Calibration for ethylene—A calibration curve was obtained by plotting Ace/At versus ethylene molar percent (% C2m), and the coefficient a_{c2}, b_{c2}, and c_{C2} were calculated from a “linear regression”.

Calibration for 1-butene—A calibration curve was obtained by plotting FCR_{C4}/Aₜ versus butane molar percent (% C₄m) and the coefficients a_{C4}, b_{C4}, and C_{C4} were calculated from a “linear regression”.

The spectra of the samples were recorded. The (Aₜ), (A_{C2}), and (FCR_{C4}) of the samples were calculated.

The ethylene content (% molar fraction C2m) of the sample was calculated as follows:

$$\% C 2 m = - {b}_{C 2} + \frac{\sqrt{{b}_{C 2}^{2} - 4 \cdot {a}_{C 2} \cdot ( {c}_{C 2} - \frac{{A}_{C 2}}{{A}_{t}} )}}{2 \cdot {a}_{C 2}}$$

The 1-butene content (% molar fraction C4m) of the sample was calculated as follows:

$$\% C 4 m = - {b}_{C 4} + \frac{\sqrt{{b}_{C 4}^{2} - 4 \cdot {a}_{C 4} \cdot ( {c}_{C 4} - \frac{{FCR}_{C 4}}{{A}_{t}} )}}{2 \cdot {a}_{C 4}}$$

a_{C4}, b_{C4}, c_{C4}, a_{C2}, b_{C2}, and c_{C2} are the coefficients of the two calibrations.

Changes from mol % to wt % were calculated by using molecular weights.

Tensile Modulus was measured according to ISO 527-2, and ISO 1873-2 on injection-molded sample.

Flexural Modulus was measured according to ISO 178, and supplemental conditions according to ISO 1873-2 on injection-molded sample.

Seal Initiation Temperature (SIT)

Preparation of the Film Specimens

Some films with a thickness of 50 μm were prepared by extruding each test composition in a single-screw Collin extruder (length/diameter ratio of screw 1:25) at a film drawing speed of 7 m/min and a melt temperature of 210-250° C.

Each resulting film was superimposed on a 1000 μm thick film of a propylene homopolymer having a xylene insoluble fraction at 25° C. of 97 wt % and a MFR L of 2 g/10 min.

The superimposed films were bonded to each other in a Carver press at 200° C. under a 9000 kg load, which was maintained for 5 minutes.

The resulting laminates were stretched longitudinally and transversally, that is, biaxially, by a factor of 6 with a Karo 4 Brueckener film stretcher at 160° C., thereby obtaining a 20 μm thick film (18 μm homopolymer+2 μm test).

Determination of the SIT.

Film Strips, 6 cm wide and 35 cm length, were cut from the center of the BOPP film. The film was superimposed with a BOPP film made of PP homopolymer. The superimposed specimens were sealed along one of the 2 cm sides with a Brugger Feinmechanik Sealer, model HSG-ETK 745. Sealing time was 5 seconds at a pressure of 0.14 MPa (20 psi). The starting sealing temperature was from about 10° C. less than the melting temperature of the test composition. The sealed strip was cut into 6 specimens, 15 mm wide, long enough to be clamped in the tensile tester grips. The seal strength 12 FE7234-EP-P1 was tested at a load cell capacity 100 N, cross speed 100 mm/min, and grip distance 50 mm. The results were expressed as the average of maximum seal strength (N). The unsealed ends were attached to an Instron machine, wherein the sample specimens were tested at a traction speed of 50 mm/min.

The test was repeated by changing the temperature as follows:

If seal strength <1.5 N, then decrease the temperature. Temperature variation was adjusted stepwise. If seal strength was close to target, steps of 1° C. were selected. If the strength was far from target, steps of 2° C. were selected.

As used herein, the term “target seal strength (SIT)” refers to the lowest temperature at which a seal strength higher or equal to 1.5 N is achieved.

Determination of the Hot Tack

The hot tack measurement was determined after sealing by Brugger HSG Heat-Sealer (with Hot Tack kit). Samples obtained from BOPP film were cut at a minimum length of 200 mm and 15 mm width and tested at the following conditions:

The temperature was set from no sealing to 130° C. with an increase of 5° C. steps; at each temperature set the weight to break the film in the neighborhood of the seal.

As used herein a break of specimen occurred when 50% or more of the seal part was open after the impact.

Preparation of the Copolymer Component A

Catalyst System

Procedure for the Preparation of the Spherical Adduct

Microspheroidal MgCl₂·pC₂H₅OH adduct was prepared according to the method described in Comparative Example 5 of Patent Cooperation Treaty Publication No. WO98/44009, with the difference that BiCl₃ in a powder form and in an amount of 3 mol % with respect to the magnesium was added before the feeding the oil.

Procedure for the Preparation of the Solid Catalyst Component

Into a 500 ml round bottom flask, equipped with a mechanical stirrer, a cooler, and a thermometer, 300 ml of TiCl₄ were introduced at room temperature under a nitrogen atmosphere. After cooling to 0° C., 9.0 g of the spherical adduct were added while stirring. Then, diethyl 3,3-dipropylglutarate was sequentially added into the flask. The amount of charged internal donor was to meet a Mg/donor molar ratio of 13. The temperature was raised to 100° C. and maintained for 2 hours. Thereafter, stirring was stopped, the solid product was allowed to settle, and the supernatant liquid was siphoned off at 100° C.

After siphoning, fresh TiCl₄ and an amount of 9,9-bis(methoxymethyl)fluorene for producing a Mg/diether molar ratio of 13 were added. The mixture was then heated at 120° C. and kept at this temperature for 1 hour under stirring. Stirring was stopped again. The solid was allowed to settle. The supernatant liquid was siphoned off. The solid was washed with anhydrous hexane six times in a temperature gradient down to 60° C. and one time at room temperature. The resulting solid was then dried under vacuum and analyzed.

Catalyst System and Prepolymerization Treatment

Before introducing the solid catalyst component into the polymerization reactor, the solid catalyst component was contacted at 15° C. for about 6 minutes with aluminum triethyl (TEAL) and dicyclopentyl dimethoxy silane (DCPMS) as external donor.

The catalyst system was then subjected to prepolymerization by maintaining the catalyst system in suspension in liquid propylene at 20° C. for about 20 minutes before introducing the catalyst system into the polymerization reactor.

Polymerization

Into a first gas phase polymerization reactor, a copolymer of propylene and 1-hexene (component (a)) was produced by feeding, in a continuous and constant flow, the prepolymerized catalyst system, hydrogen (used as molecular weight regulator), propylene, and 1-hexene, in the gas state. The polypropylene copolymer produced in the first reactor was discharged, in a continuous flow, and introduced, in a continuous flow, into a second gas phase polymerization reactor, together with quantitatively constant flows of hydrogen, 1-hexene, and propylene, in the gas state.

The polypropylene copolymer produced in the second reactor was discharged, in a continuous flow, and, after having been purged of unreacted monomers, was introduced, in a continuous flow, into a third gas phase polymerization reactor, together with quantitatively constant flows of hydrogen, 1-hexene, and propylene, in the gas state.

The polymerization conditions are reported in Table 1.

TABLE 1

| | | Ex 1 |
|---|---|---|
| catalyst feed | g/h | 14.3 |
| TEAL/solid catalyst component | g/g | 4 |
| weight ratio | | |
| TEAL/D donor weight ratio | g/g | 10 |
| Prepolymerization | | |
| temperature | | 20 |
| Residence time | | 34 |
| First gas phase reactor | | |
| Polymerization temperature | ° C. | 75 |
| MFR | g/10 min | 5.4 |
| Pressure | barg | 15 |
| H2/C3 | mol/mol | 0.0035 |
| C6/C6 + C3 | mol/mol | 0.135 |
| split first reactor (amount A) | wt % | 24 |
| Second gas phase reactor | | |
| Polymerization temperature | | 75 |
| Pressure | barg | 15 |
| MFR* | g/10 min | 6.1 |
| H2/C3 | mol/mol | 0.035 |
| C6/C6 + C3 | mol/mol | 0.194 |
| split second reactor (amount B) | wt % | 26 |
| Third gas phase reactor | | |
| Polymerization temperature | ° C. | 65 |
| Pressure | barg | 14 |
| MFR* | g/10 min | 6.2 |
| H2/C3 | mol/mol | 0.051 |
| C2/C2 + C3 | mol/mol | 0.032 |
| split third reactor (amount C) | wt % | 50 |

C3=propylene; C6=1-hexene; C2=ethylene; H2=hydrogen

The polymer obtained according to Table 1 was mixed with the following additives: 0.05% Irg.1010; 0.1% Irg.168, and 0.05% CaSt. The polymer mixture was then pelletized. The features of the compositions are reported in Table 2.

TABLE 2

| | | Ex1 |
|---|---|---|
| component a) | | |
| MFR | g/10′ | 5.4 |
| split | wt % | 24 |
| C6- content | wt % | 7.3 |
| Xylene soluble 25° C. | Wt % | 18.1 |
| component b) | | |
| MFR | gr/10′ | 6.8** |
| C6 content | wt % | 12.2* |
| split | | 26 |
| Xylene soluble 25° C. (a + b) | Wt % | 28.1 |
| C6 Xs fraction | Wt % | 25.4 |
| component c) | | |
| MFR | gr/10′ | 5.5** |
| C2 content | Wt % | 4.7* |
| Xylene soluble 25° C. | Wt % | 6.0^{#} |
| C2 Xs fraction | Wt % | 15 |
| composition | | |
| MFR tot | g/10′ | 5.8 |
| Xylene Soluble 25° C. | wt % | 17.1 |
| Tm | ° C. | 131.3 |
| Tc | 0 0 | 85.9 |
| C6 tot | wt % | 4.9 |
| Tm − Tc | ° C. | 45.4 |
| Gels ≥ 0.1 mm | nr/m2 | 100 |

C3 = propylene; C6 = 1-hexene ; C2 ethylene;
**calculated by using the formula logMFRtot = XalogMFRa + XblogMFRb;
*calculated by using the formula Ytot = XaYa + XbYb wherein Y is the comonomer content and Xa and Xb are the splits (Xa + Xb = 1).
# calculated by using the formula XStot = XaXsa + XbXsb wherein X is the total xylene soluble content, Xsa and Xsb are the partial xylene soluble contents, and Xa and Xb are the splits (Xa + Xb = 1).

Component B

Component B was Koattro DP 8310M 1-butene ethylene copolymer, which was commercially available from LyondellBasell.

The features of component B are reported in Table 3.

TABLE 3

| | | Component B |
|---|---|---|
| MFR 190° C. 2.16 kg | g/10 min | 3.5 |
| Flexural modulus | MPa | 120 |
| Tm | ° C. | 94 |
| Ethylene content | Wt % | 3.7 |

Various amounts of component B were blended with component A. A two-layer BOPP film was produced for each blend. The two layers were made by the same component. The seal initiation temperature was measured. Table 4 reports the SIT for each sample.

TABLE 4

| ex | Comp B | SIT ° C. |
|---|---|---|
| Comp 1 | 0 | 87 |
| 2 | 10 wt % | 68 |
| 3 | 15 wt % | 65 |
| 4 | 20 wt % | 63 |

Hot Tack

The hot tack of the films of comparative example 1 and examples 2-4 were measured at various temperature. The results are reported in Table 5.

TABLE 5

| | Comp | | | |
|---|---|---|---|---|
| | Ex 1 | Ex 2 | Ex 3 | Ex 4 |
| Temp ° C. | Hot tack g | Hot tack g | Hot tack g | Hot tack g |
| 80 | 108 | 198 | 238 | 413 |
| 90 | 181 | 163 | 283 | 288 |
| 110 | 358 | 93 | 343 | 693 |
| 120 | 268 | 200 | 693 | 400 |

### Comparative Example 5

Comparative component B1 was a 1-butene ethylene copolymer, commercially available under the tradename Toppyl PB 8220M from Lyondellbasell. The features of this polymer are reported in Table 6.

TABLE 6

| | | Component B1 |
|---|---|---|
| MFR 190° C. 2.16 kg | g/10 min | 2.5 |
| Flexural modulus | MPa | 140 |
| Tm | ° C. | 97 |
| Ethylene content | Wt % | 2.7 |

20 wt % of component B1 was blended with 80 wt % of component A. A two-layer BOPP film was produced for each blend. The two layers were made by the same component. The seal initiation temperature was measured to be 65° C., while the composition of example 4 had a SIT of 63° C. Hot tack of comparative example 6 was measured.

TABLE 7

| | Ex 5 | Comp Ex 6 |
|---|---|---|
| Temp ° C. | Hot tack g | Hot tack g |
| 80 | 413 | 288 |
| 90 | 288 | 273 |
| 100 | 288 | 238 |
| 110 | 344 | 331 |

1. A polymer composition comprising:
A) from 70 wt % to 95 wt % of a propylene-based polymer composition comprising:
a) from 15 wt % to 35 wt % of-a copolymer of propylene and 1-hexene containing from 6.2 to 8.5% by weight, based upon the total weight of the copolymer of propylene and 1-hexene (a), of 1-hexene derived units and having a Melt Flow Rate (MFR, measured according to ASTM D 1238-13, 230° C./2.16 kg, that is, at 230° C., with a load of 2.16 kg) of from 3.5 to 8.5 g/10 min;
b) from 15 wt % to 35 wt % of-a copolymer of propylene and 1-hexene containing from 10.4 wt % to 14.5 wt %, based upon the total weight of the copolymer of propylene and 1-hexene (b), of 1-hexene derived units and having a Melt Flow Rate (MFR, measured according to ASTM D 1238-13, 230° C./2.16 kg, that is, at 230° C., with a load of 2.16 kg) of from 3.5 to 8.5 g/10 min; and
c) from 38 wt % to 68 wt % of a copolymer of propylene and ethylene containing from 3.4 wt % to 5.7 wt %, based upon the total weight of the copolymer of propylene and ethylene (c), of ethylene derived units, having a Melt Flow Rate (MFR, measured according to ASTM D 1238-13, 230° C./2.16 kg, that is, at 230° C., with a load of 2.16 kg) from 3.5 to 12.0 g/10 min, and having a xylene soluble content at 25° C. of from 3.7 wt % to 7.8 wt %, based upon the total weight of the copolymer of propylene and ethylene (c);
the sum of the amount of components a), b) and c) in the propylene-based polymer composition being 100 wt %;
wherein:
i) the total amount of 1-hexene derived units of the components a) and b) ranges from 9.4 wt % to 11.6 wt %, based upon the combined weight of components a) and b);
ii) the xylene soluble content at 25° C. ranges from 14.2 wt % to 19.3 wt %, based upon the total weight of the propylene-based polymer composition;
iii) the 1-hexene-derived units content ranges from 3.7 wt % to 6.4 wt %, based upon the total weight of the propylene-based polymer composition; and
iv) the propylene-based polymer composition has a melting point ranging from 128° C. to 135° C., measured by DSC, and
B) from 5 wt % to 30 wt % of a copolymer of 1-butene and ethylene containing from 3.0 wt % to 4.2 wt %, based upon the total weight of the copolymer of 1-butene and ethylene, of ethylene derived units and having a Melt Flow Rate (measured according to ISO 1133-1 at 190° C., 2.16 Kg) ranging from 1.0 to 5.5 g/10 min, a flexural modulus (measured according to ISO 178) ranging from 80 MPa to 250 and a melting temperature (measured according to ISO 11357-2013, form I) ranging from 83° C. to 108° C.;
wherein
the sum of the amounts of A) and B) in the polymer composition being 100 wt %.

2. The polymer composition according to claim 1, wherein component A) ranges from 74 wt % to 87 wt % and component B) ranges from 13 wt % to 26 wt %.

3. The polymer composition according to claim 1, wherein component B) contains from 3.2 wt % to 4.0 wt % of ethylene derived units.

4. The polymer composition according to claim 1, wherein component B) has a Melt Flow Rate: measured according to ISO 1133-1-(190° C., 2.16 Kg) ranging from 2.1 to 4.8 g/10 min.

5. The polymer composition according to claim 1, wherein component B) has a melting temperature measured according to ISO 11357-2013, form I, ranging from 84° C. to 103° C.

6. The polymer composition according to claim 1, wherein component a) ranges from −20 wt % to 31 wt %; component b) ranges from −20 wt % to 31 wt %; and component c) ranges from 42 wt % to 62 wt %.

7. The polymer composition according to claim 1, wherein component a) contains from 6.8 wt % to 8.1 wt % of 1-hexene derived units.

8. The polymer composition according to claim 1, wherein component b) contains from 11.2 wt % to 13.9 wt % of 1-hexene derived units.

9. The polymer composition according to claim 1, wherein component c) contains from 3.9 wt % to 5.1 wt % of ethylene derived units.

10. The polymer composition according to claim 1, wherein the sum of components a)+b) have a 1-hexene derived units content in the fraction soluble in xylene at 25° C. between 18.0 wt % and 32.0 wt % based upon the combined weight of components a) and b).

11. The polymer composition according to claim 1, wherein the xylene soluble content at 25° C. ii) ranges from 15.3 wt % to 18.7 wt %, based upon the total weight of the propylene-based polymer composition.

12. The polymer composition according to claim 1, wherein the 1-hexene derived units content ii) ranges from 3.9 wt % to 5.4 wt %, based upon the total weight of the propylene-based polymer composition.

13. The polymer composition according to claim 1, wherein component c) has an ethylene derived units content in the fraction soluble in xylene at 25° C. between 10.0 wt % and 17.0 wt %, based upon the total weight of the copolymer of propylene and ethylene (c).

14. A film comprising the polymer composition according to claim 1.

15. A multilayer film comprising the polymer composition according to claim 1.
